(19) United States
(12) Patent Application Publication
(10) Pub. No.: US 2010/0225706 A1
(43) Pub. Date: Sep. 9, 2010

(54) Liquid Droplet Jetting Apparatus and Liquid Droplet Jetting Method

(75) Inventor: Teppei Yamamoto, Kanagawa (JP)

Correspondence Address: FISH & RICHARDSON P.C., PO BOX 1022, MINNEAPOLIS, MN, 55440-1022, US

(73) Assignee: FUJIFILM Corporation

(21) Appl. No.: 12/711,994

(22) Filed: Feb. 24, 2010

(30) Foreign Application Priority Data
Mar. 3, 2009 (JP) 2009049464

(51) Int. Cl. B41J 2/04

(52) U.S. Cl. 347/54

(57) ABSTRACT

A liquid droplet jetting apparatus is provided. The liquid droplet jetting apparatus includes: a plurality of pressure chambers, in each of which is disposed a nozzle for jetting a liquid filling the pressure chambers; a common supply channel that is equipped with branching channels connected to each of the pressure chambers and which supplies the liquid to each of the pressure chambers from the branching channels such that the liquid fills each of the pressure chambers; and a pressure applying component that applies pressure to the liquid filling the pressure chambers to cause the liquid to be jetted from the nozzles such that a frequency of pressure waves propagating in the liquid inside the common supply channel when pressure has been applied to the liquid filling the pressure chambers does not become equal to a resonance frequency of the common supply channel.

### CROSS-REFERENCE TO RELATED APPLICATION

This application claims priority under 35 USC 119 from Japanese Patent Application No. 2009-049464 filed on Mar. 3, 2009, the disclosure of which is incorporated by reference herein.

### BACKGROUND OF THE INVENTION

1. Field of the Invention

The present invention relates to a liquid droplet jetting apparatus that causes a liquid to be jetted from nozzles and to a liquid droplet jetting method.

2. Description of the Related Art

In recent years, liquid droplet jetting apparatus that form dots configuring an image on a recording medium by jetting a liquid from nozzles have become pervasive.

Incidentally, in this type of liquid droplet jetting apparatus, there has been the problem that image quality drops when forming an image at a high speed and the speed of image formation drops when forming an image with high image quality.

In order to solve this problem, in Japanese Patent Application Laid-Open Publication (JP-A) No. 2007-30311, there is disclosed a method of driving a multidrop inkjet printer head that uses, as a drive waveform applied to each pressure chamber of an inkjet printer head, a first drive waveform to which a boost waveform that causes the pressure chambers to preliminarily vibrate has been added or a second drive waveform to which a damping waveform that dampens the vibration of the pressure chambers has been added and varies the basic jetting amount of ink that is jetted from the pressure chambers.

Further, there have also been instances where unnecessary ink liquid is jetted and image quality drops because of the affect of residual vibration occurring in the image formation cycle, such as when causing the ink liquid to be continuously jetted.

In order to solve this problem, an inkjet recording apparatus that performs gradation printing by varying the number of ink droplets jetted from the nozzles of the pressure chambers is known. In this inkjet recording apparatus, assuming that Td represents a cycle when the inkjet recording apparatus jets the ink droplets, N represents a number of ink droplets of maximum gradation and Te represents downtime after operation for jetting the last ink droplets of maximum gradation has ended to until the next 1 cycle time is started, 1 cycle time Tc becomes equal to Td×N+Te, so assuming that Ta represents pressure propagation time when pressure waves propagate from a back end to a front end of each pressure chamber, Td and Te are set such that Td=n×Ta (where n=1, 2, 3, . . . ) and Te=(0.5+m)×Ta (where m=1, 2, 3, . . . ), the energization waveform of each gradation is set such that the output timings of the energization waveforms for jetting the last ink droplets in each gradation match, and drive components that cause the volumes of the pressure chambers to vary are operated by the energization waveforms following this setting.

However, in the technologies disclosed in JP-A No. 2007-30311 and JP-A No. 2008-93950, pressure is applied to the liquid filling the pressure chambers, whereby resonance occurs in a common supply channel that supplies the liquid to the pressure chambers, the pressure propagates unevenly to each pressure chamber, and the speed of the liquid supplied to each pressure chamber becomes uneven per pressure chamber; as a result, as shown in FIG. 11, there is the problem that variations occur in speed when the liquid filling pressure chambers 84′ is jetted as liquid droplets from nozzles 82′ and there is the potential for the liquid to not be jetted from the nozzles.

### SUMMARY OF THE INVENTION

The present invention has been made in order to address the above-described problem, and it is an object thereof to provide a liquid droplet jetting apparatus which, when jetting a liquid from nozzles by applying pressure to a liquid filling pressure chambers, can control a common supply channel that supplies the liquid to the pressure chambers from resonating.

One aspect of the present invention is a liquid droplet jetting apparatus including: a plurality of pressure chambers, in each of which is disposed a nozzle for jetting a liquid filling the pressure chambers; a common supply channel that is equipped with branching channels connected to each of the pressure chambers and which supplies the liquid to each of the pressure chambers from the branching channels such that the liquid fills each of the pressure chambers; and a pressure applying component applies pressure to the liquid filling the pressure chambers to cause the liquid to be jetted from the nozzles such that a frequency of pressure waves propagating in the liquid inside the common supply channel when pressure has been applied to the liquid filling the pressure chambers does not become equal to a resonance frequency of the common supply channel.

### BRIEF DESCRIPTION OF THE DRAWINGS

FIG. 1 is a side view showing the configuration of an image forming apparatus pertaining to a first embodiment of the present invention;

FIG. 2 is a side view showing the configuration of a nozzle surface of an inkjet line head pertaining to the first embodiment of the present invention;

FIG. 3 is a plan view showing a structural example of the inkjet line head pertaining to the first embodiment of the present invention;

FIG. 4 is a longitudinal sectional view showing a structural example of the inkjet line head pertaining to the first embodiment of the present invention;

FIG. 5 is a block diagram showing the configuration of relevant portions of an electrical system of the image forming apparatus pertaining to the first embodiment of the present invention;

FIG. 6A and FIG. 6B are graphs showing sizes of drive voltages applied to actuators when causing ink to be jetted from nozzles in the image forming apparatus pertaining to the first embodiment of the present invention;

FIG. 7 is a graph showing the size of a drive voltage applied to actuators when causing ink to be jetted from nozzles in small droplet formation processing pertaining to the first embodiment of the present invention;

FIG. 8 is a schematic diagram showing pressure distributions of ink liquid inside a common supply channel when the common supply channel is in a resonant state and when the common supply channel is not in a resonant state;

FIG. 9 is a flowchart showing a flow of processing by a liquid droplet jetting program pertaining to the first embodiment of the present invention;

FIG. 10A and FIG. 10B are graphs showing sizes of drive voltages applied to actuators when causing ink to be jetted from nozzles in an image forming apparatus pertaining to a second embodiment of the present invention; and

FIG. 11 is a schematic diagram showing variations in the speed of liquid droplets jetted from nozzles that arise as a result of resonance occurring in a common supply channel.

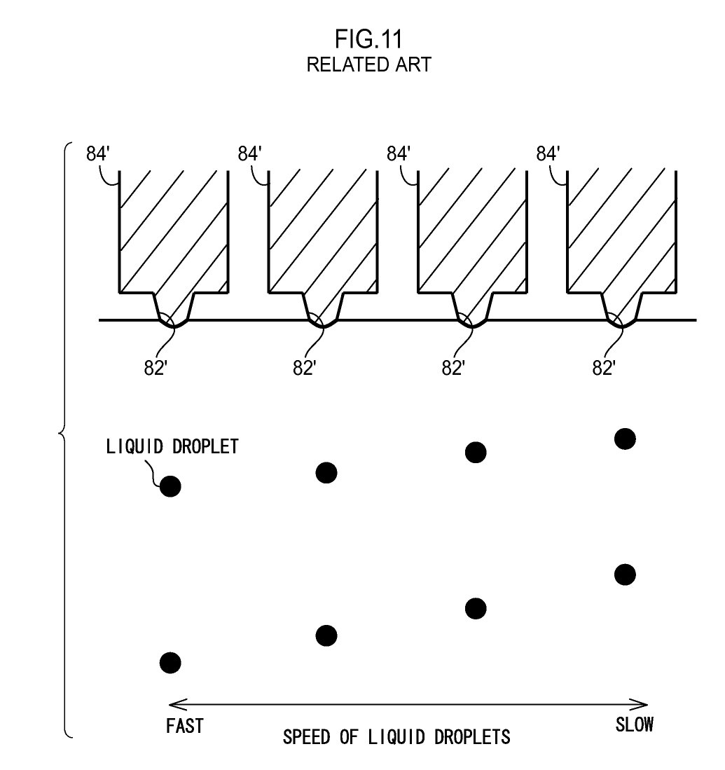

### DETAILED DESCRIPTION OF THE INVENTION

Embodiments of the present invention will be described in detail below with reference to the drawings.

### First Embodiment

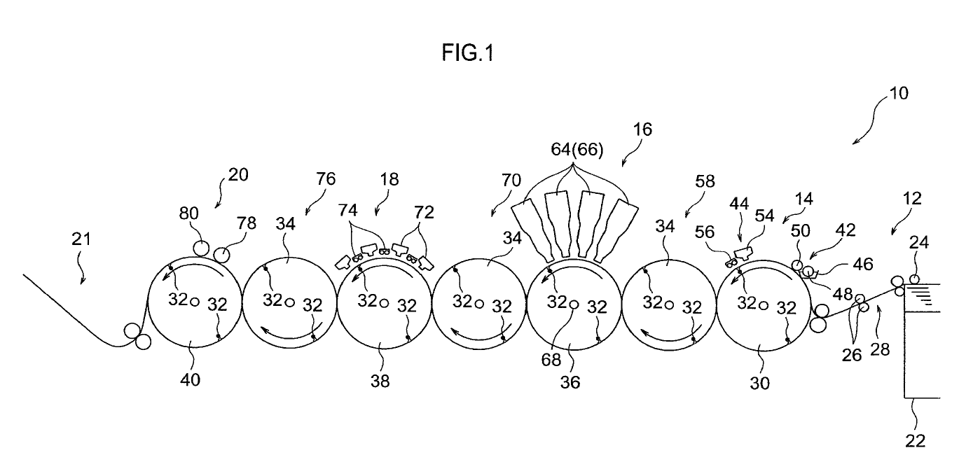

First, the overall configuration of an image forming apparatus 10 pertaining to the present embodiment will be described with reference to FIG. 1.

As shown in FIG. 1, in the image forming apparatus 10 pertaining to the present embodiment, there is disposed a paper feeding and conveying section 12 that feeds and conveys, upstream in a conveyance direction of sheets of paper (hereinafter called “the paper”) serving as a recording medium, the paper. Downstream of this paper feeding and conveying section 12, there are disposed, along the conveyance direction of the paper, a processing liquid applying section 14 that applies a processing liquid to a recording surface of the paper, an image forming section 16 that forms an image with ink liquid on the recording surface of the paper, an ink drying section 18 that dries the image that has been formed on the recording surface, an image fixing section 20 that fixes the dried image to the paper, and a discharging section 21 that discharges the paper to which the image has been fixed.

Each processing section will be described below.

### (Paper Feeding and Conveying Section)

In the paper feeding and conveying section 12, there is disposed a loading component 22 into which the paper is loaded, and downstream of the loading component 22 in the conveyance direction of the paper (hereinafter, sometimes “the conveyance direction of the paper” will be omitted), there is disposed a paper feeding component 24 that feeds, one sheet at a time, the paper that has been loaded into the loading component 22. The paper that has been fed by this paper feeding component 24 is conveyed to the processing liquid applying section 14 via a conveying component 28 that is configured by plural pairs of rollers 26.

### (Processing Liquid Applying Section)

In the processing liquid applying section 14, there is rotatably disposed a processing liquid applying drum 30 that is configured by a cylindrical member around whose outer peripheral surface the paper is wrapped and which conveys the paper by rotating. On this processing liquid applying drum 30, there is disposed a holding member 32 that holds the leading edge portion of the paper between itself and the processing liquid applying drum 30 to hold the paper, and in a state where the paper is held on the surface of the processing liquid applying drum 30 via the holding member 32, the paper is conveyed downstream by the rotation of the processing liquid applying drum 30.

It will be noted that intermediate conveying drums 34, an image forming drum 36, an ink drying drum 38 and an image fixing drum 40 that will be described later are also configured in the same manner as the processing liquid applying drum 30 such that a holding member 32 is disposed. Additionally, delivery of the paper from an upstream drum to a downstream drum is performed by this holding member 32.

On the upper portion of the processing liquid applying drum 30, there are disposed a processing liquid applying device 42 and a processing liquid drying device 44 along the circumferential direction of the processing liquid applying drum 30; the processing liquid is applied to the recording surface of the paper by the processing liquid applying device 42, and the processing liquid is dried by the processing liquid drying device 44.

Here, the processing liquid has the effect that it reacts with the ink to agglutinate the color material (pigment) and promotes separation of the color material (pigment) and the solvent. In the processing liquid applying device 42, there is disposed a storing component 46 in which the processing liquid is stored, and part of a gravure roller 48 is immersed in the processing liquid.

A rubber roller 50 is disposed in pressure-contact with this gravure roller 48, the rubber roller 50 contacts the recording surface (front surface) side of the paper, and the processing liquid is applied. Further, a squeegee contacts the gravure roller 48 and controls the amount of the processing liquid applied to the recording surface of the paper.

It is ideal for the processing liquid film thickness to be sufficiently smaller than head-jetted liquid droplets (ink droplets). For example, in the case of a 2-pl jetting amount, the average diameter of head-jetted liquid droplets is 15.6 μm, and when the processing liquid film thickness is thick, the ink dots float in the processing liquid without contacting the recording surface of the paper. In order to obtain a landing dot diameter of 30 μm or greater with a 2-pl jetting amount, it is preferred to make the processing liquid film thickness 3 μm or less.

In the processing liquid drying device 44, a hot-air nozzle 54 and an infrared heater 56 (hereinafter called “the IR heater 56”) are disposed near the surface of the processing liquid applying drum 30. A solvent such as water in the processing liquid is evaporated by the hot-air nozzle 54 and the IR heater 56 to form a solid or thin-film processing liquid layer on the recording surface side of the paper. By making the processing liquid into a thin film in the processing liquid drying step, dots obtained as a result of the ink droplets being jetted in the image forming section 16 contact the paper surface such that the necessary dot diameter is obtained, and it is easy to obtain action where the ink reacts with the processing liquid that has been made into a thin film to agglutinate the color material and the ink solidifies on the paper surface.

In this manner, the paper onto whose recording surface the processing liquid has been applied and dried in the processing liquid applying section 14 is conveyed to an intermediate conveying section 58 that is disposed between the processing liquid applying section 14 and the image forming section 16.

### (Intermediate Conveying Section)

In the intermediate conveying section 58, there is rotatably disposed an intermediate conveying drum 34, the paper is held on the surface of the intermediate conveying drum 34 via the holding member 32 that is disposed on the intermediate conveying drum 34, and the paper is conveyed downstream by the rotation of the intermediate conveying drum 34.

### (Image Forming Section)

In the image forming section 16, there is rotatably disposed an image forming drum 36, the paper is held on the surface of the image forming drum 36 via the holding member 32 that is disposed on the image forming drum 36, and the paper is conveyed downstream by the rotation of the image forming drum 36.

On the upper portion of the image forming drum 36, a head unit 66 configured by single-pass inkjet line heads 64 is disposed near the surface of the image forming drum 36. In this head unit 66, inkjet line heads 64 of at least YMCK, which are basic colors, are arrayed along the circumferential direction of the image forming drum 36, and images of each color are formed by dots on the processing liquid layer that has been formed on the recording surface of the paper in the processing liquid applying section 14.

The processing liquid has the effect of agglutinating, to the processing liquid, the color material (pigment) and latex particles dispersed in the ink, and the processing liquid forms an aggregate where color material flow or the like does not occur on the paper. As one example of the reaction between the ink liquid and the processing liquid, an acid is included in the processing liquid, a mechanism that destroys pigment dispersion and agglutinates the pigment by lowering PH is used, and jetting interference resulting from color material running, color mixing between each color ink and liquid union when the ink droplets land is avoided.

The inkjet line heads 64 perform jetting synchronously with an encoder that is disposed on the image forming drum 36 and detects its rotational speed, whereby the inkjet line heads 64 are capable of determining landing positions with high accuracy and reducing jetting unevenness independent of the vibration of the image forming drum 36, the accuracy of a rotating shaft 68 and the drum surface speed.

It will be noted that the head unit 66 is configured to be capable of evacuating from the upper portion of the image forming drum 36, and maintenance operation such as cleaning the nozzle surfaces of the inkjet line heads 64 and discharging sticky ink is implemented by causing the head unit 66 to evacuate from the upper portion of the image forming drum 36.

The paper on whose recording surface an image has been formed by the ink liquid is conveyed by the rotation of the image forming drum 36 to an intermediate conveying section 70 that is disposed between the image forming section 16 and the ink drying section 18, but description of the intermediate conveying section 70 will be omitted because the configuration of the intermediate conveying section 70 is substantially the same as that of the intermediate conveying section 58.

### (Ink Drying Section)

In the ink drying section 18, there is rotatably disposed an ink drying drum 38, and on the upper portion of the ink drying drum 38, plural hot-air nozzles 72 and plural IR heaters 74 are disposed near the surface of the ink drying drum 38. Because of the hot air resulting from the hot-air nozzles 72 and the IR heaters 74, the solvent that has been separated by the color material agglutination action is dried and a thin-film image layer is formed in an image formation region of the paper.

The temperature of the hot air differs depending on the conveyance speed of the paper, but ordinarily it is set to 50° C. to 70° C. The evaporated solvent is discharged to the outside of the image forming apparatus 10 together with air, but the air is recovered. This air may be cooled by a cooler/radiator or the like and recovered as a liquid.

The paper on whose recording surface the image has dried is conveyed by the rotation of the ink drying drum 38 to an intermediate conveyance section 76 that is disposed between the ink drying section 18 and the image fixing section 20, but description of the intermediate conveying section 76 will be omitted because the configuration of the intermediate conveying section 76 is substantially the same as that of the intermediate conveying section 58.

### (Image Fixing Section)

In the image fixing section 20, there is rotatably disposed an image fixing drum 40, and the image fixing section 20 has a function where the latex particles in the thin image layer that has been formed on the ink drying drum 38 are heated and pressurized such that the latex particles melt and become anchored and fixed onto the paper.

On the upper portion of the image fixing drum 40, a heat roller 78 is disposed near the surface of the image fixing drum 40. This heat roller 78 is configured by a metal pipe such as aluminium that has good thermal conductivity and a halogen lamp that is incorporated inside the metal pipe, and thermal energy equal to or greater than a Tg temperature of the latex is applied by the heat roller 78. Thus, the heat roller 78 melts the latex particles and pushes the latex particles into uneven portions of the paper to perform fixing and also levels unevenness in the image surface to make it possible to obtain luster.

Downstream of the heat roller 78, there is disposed a fixing roller 80. This fixing roller 80 is disposed in a state where it is in pressure-contact with the surface of the image fixing drum 40 such that a nipping force is obtained between the fixing roller 80 and the image fixing drum 40. For this reason, at least one of the fixing roller 80 and the image fixing drum 40 is given a configuration where it has an elastic layer on its surface and has an even nip width with respect to the paper.

Because of the step described above, the paper on whose recording surface the image has been fixed is conveyed by the rotation of the image fixing drum 40 to the discharge section 21 that is disposed downstream of the image fixing section 20.

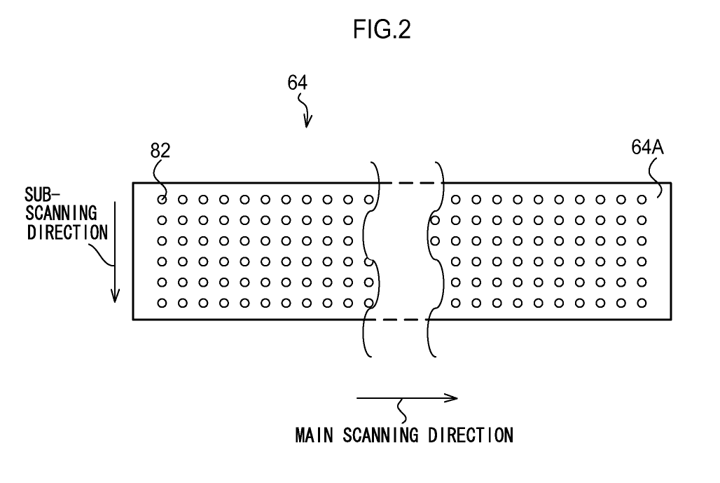

In FIG. 2, there is shown a nozzle surface 64A of the inkjet line heads 64. It will be noted that the configurations of the nozzle surface 64A of each of the inkjet line heads 64 corresponding to YMCK and the structures of the later-described inkjet line heads 64 are all the same.

Further, sub-scanning will be defined as repeatedly performing printing of one line (a line resulting from one row of dots or a line comprising plural rows of dots) that has been formed by main scanning by relatively moving the inkjet line head 64 and the paper. Additionally, the direction represented by 1 line (or the longitudinal direction of a band-like region) that is recorded by main scanning will be called a main scanning direction, and the direction in which sub-scanning is performed will be called a sub-scanning direction. That is, in the present embodiment, the conveyance direction of the paper is the sub-scanning direction, and the direction orthogonal thereto is the main scanning direction.

In the nozzle surface 64A, there are disposed nozzles 82 for jetting the liquid filling later-described pressure chambers 84. It will be noted that the inkjet line head 64 pertaining to the present embodiment has a structure where the nozzles 82 for jetting the ink liquid are two-dimensionally arrayed (in a matrix) in the main scanning direction and the sub-scanning direction. Further, in the image forming apparatus 10 pertaining to the present embodiment, there are 1200 of the nozzles 82 per inch (1200 nozzles/inch), but it goes without saying that the number of the nozzles 82 may also be densified even more.

Moreover, in order to densify the pitch of the dots that are formed on the paper by the ink liquid that is jetted from the nozzles 82, the nozzles 82 may be arrayed in a higher density by numerously arraying the nozzles 82 in a grid with a constant array pattern along a column direction following the main scanning direction and a diagonal row direction having a constant angle θ that is not orthogonal with respect to the main scanning direction.

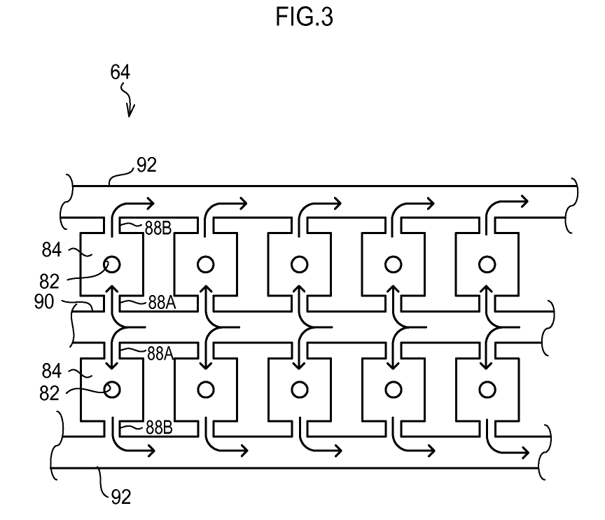

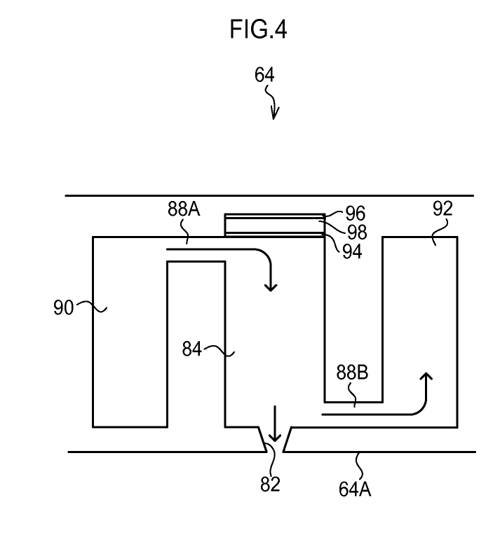

In FIG. 3, there is shown a plan view showing a structural example of the inkjet line head 64. It will be noted that the arrows shown in FIG. 3 and later-described FIG. 4 represent directions of the ink liquid flowing inside the inkjet line head 64.

The inkjet line head 64 pertaining to the present embodiment is equipped with plural pressure chambers 84, in each of which is disposed the nozzle 82, a common supply channel 90 that is equipped with branching channels 88A connected to each of the pressure chambers 84 and which supplies the ink liquid to each of the pressure chambers 84 from the branching channels 88A such that the ink liquid fills each of the pressure chambers 84, and circulation channels 92 that are equipped with branching channels 88B connected to each of the pressure chambers 84 and into which the ink liquid filling each of the pressure chambers 84 flows from the branching channels 88B.

The pressure chambers 84 have a substantially square planar shape, with the branching channels 88A to which the ink liquid is supplied being connected to one side and the branching channels 88B being connected to the side opposing the side to which the branching channels 88A are connected. It will be noted that, in the image forming apparatus 10 pertaining to the present embodiment, a square shape is used as the planar shape of the pressure chambers 84, but the planar shape of the pressure chambers 84 is not limited to a square shape; another shape may be used for the planar shape of the pressure chambers 84, such as a rhombic planar shape, a rectangular planar shape, a pentagonal planar shape, a hexagonal planar shape or another polygonal planar shape, or a circular planar shape or elliptical planar shape.

The common supply channel 90 and the circulation channels 92 are communicated with an ink tank that is an ink supply source. The common supply channel 90 supplies the ink liquid from the ink tank to the pressure chambers 84 via the branching channels 88A. The circulation channels 92 cause the ink liquid flowing in from the pressure chambers 84 via the branching channels 88B to be circulated to the ink tank.

Further, as shown in the longitudinal sectional view of FIG. 4, the common supply channel 90 is communicated at upper portions of side surfaces of the pressure chambers 84 via the branching channels 88A, and the circulation channels 92 are communicated at lower portions of side surfaces of the pressure chambers 84 via the branching channels 88B. For this reason, the ink liquid flows from the pressure chambers 84 to the circulation channels 92 because of a pressure difference between the ink liquid inside the common supply channel 90 and the ink liquid inside the circulation channels 92, separate from operation of later-described actuators 98.

Moreover, as shown in FIG. 4, an actuator 98 that applies pressure to the ink liquid filling the pressure chamber 84 to cause the ink liquid to be jetted from the nozzle 82 is joined to a pressure plate (a diaphragm that doubles as a common electrode) 94 that configures a surface (the top surface in FIG. 4) of part of the pressure chamber 84. It will be noted that an individual electrode 96 is disposed on the surface of each actuator 98 that is opposite the surface that contacts the pressure plate 94.

The actuator 98 deforms as a result of a drive voltage being applied between the individual electrode 96 and the common electrode, whereby the volume of the pressure chamber 84 changes and the ink liquid is jetted from the nozzle 82 because of a change in pressure accompanying this change in volume. It will be noted that a piezoelectric element using a piezoelectric body such as lead zirconate titanate or barium titanate is suitably used for the actuator 98. Further, when displacement of the actuator 98 returns to normal after jetting of the ink liquid, new ink again fills the pressure chamber 84 from the common supply channel 90 through the branching channel 88A.

The image forming apparatus 10 pertaining to the present embodiment causes the ink liquid to be jetted from the nozzles 82 by controlling the driving of the actuators 98 corresponding to each of the nozzles 82 in accordance with dot arrangement data generated from image information. Additionally, the image forming apparatus 10 performs processing (hereinafter called “image formation processing”) to form an image represented by image information on the paper by conveying the paper at a constant speed in the sub-scanning direction and controlling the ink jetting timing of each of the nozzles 82 to match that conveyance speed.

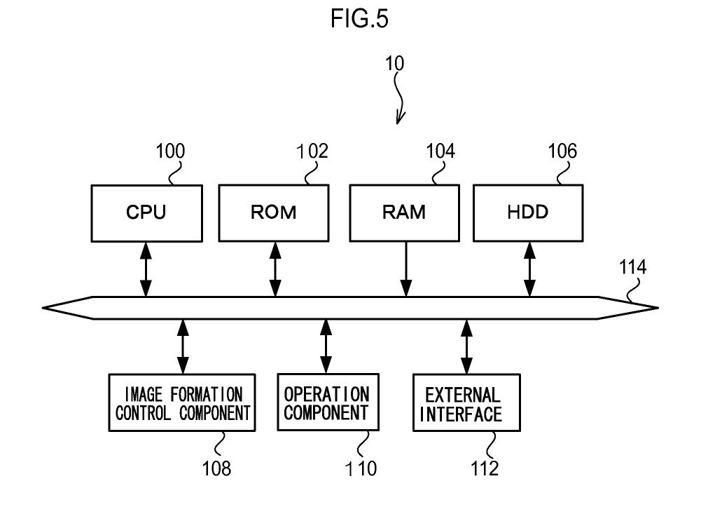

In FIG. 5, there is shown the configuration of relevant portions of an electrical system of the image forming apparatus 10 pertaining to the present embodiment.

The image forming apparatus 10 is equipped with a central processing unit (CPU) 100 that controls operation of the entire image forming apparatus 10, a read-only memory (ROM) 102 in which various programs, various parameters and various table information have been stored beforehand, a random access memory (RAM) 104 that is used as a work area and the like during execution of various programs by the CPU 100, and a hard disk drive (HDD) 106 that stores various information such as image information received via a later-described external interface 112.

Further, the image forming apparatus 10 is equipped with an image formation control component 108 that controls operation of the image forming section 16 and the ink drying section 18 and the like, an operation component 110 that is disposed with operation buttons and a numerical keypad to which various operation instructions are inputted and a display for displaying various messages and the like, and an external interface 112 that transmits and receives various information such as image information to and from an external terminal device.

The CPU 100, the ROM 102, the RAM 104, the HDD 106, the image formation control component 108, the operation component 110 and the external interface 112 are electrically interconnected via a system bus 114. Consequently, the CPU 100 can access the ROM 102, the RAM 104 and the HDD 106, can transmit and receive various information to and from the terminal device via the external interface 112, can control operation of the image forming section 16 and the ink drying section 18 and the like via the image formation control component 108, and can understand states of operation with respect to the operation component 110 and display various messages resulting from the operation component 110.

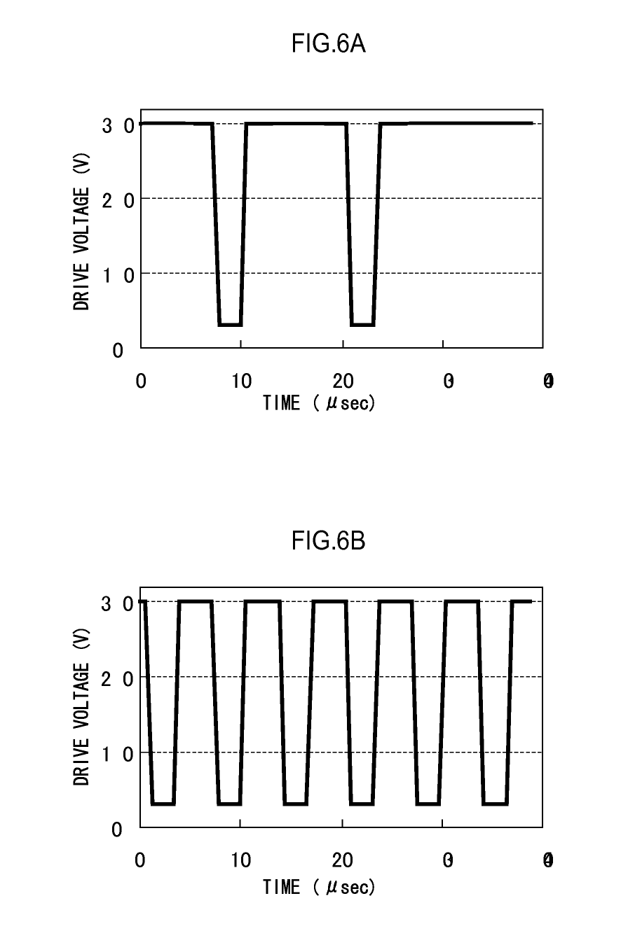

In FIG. 6A and FIG. 6B, there are shown sizes (pulse waveforms) of drive voltages applied to the actuators 98 when causing the ink liquid to be jetted from the nozzles 82 in the image forming apparatus 10 pertaining to the present embodiment.

It will be noted that, in the image forming apparatus 10 pertaining to the present embodiment, when causing the ink liquid to be jetted from the nozzles 82, a voltage (hereinafter called “the reference voltage value”) of a predetermined size (as one example, about 30 V) being applied to the actuators 98 is changed to a voltage (hereinafter called “the jetting voltage value”) of a smaller size (as one example, 10 V or less). Thus, the actuators 98 deform (are driven) such that pressure that causes the ink liquid to be jetted (hereinafter called “the jetting pressure”) is applied to the ink liquid filling the pressure chambers 84 and the ink is jetted from the nozzle 82.

It will be noted that, before the drive voltage applied to the actuators 98 is returned to the reference voltage value, a voltage (hereinafter called “the non-jetting voltage value”) of a size that applies, to the ink liquid, pressure that does not cause the ink liquid to be jetted from the nozzle 82 (hereinafter called “the non jetting pressure”) may also be applied to the actuators 98. The purpose of applying the non jetting pressure to the ink liquid is to control the state of meniscuses formed in the nozzles 82, and the size of the non-jetting voltage value is made equal to a size that can control vibration of the meniscuses after the ink liquid has been jetted. Thus, continuous jetting of the ink liquid can be performed without being affected by vibration of the meniscuses.

Further, in the image forming apparatus 10 pertaining to the present embodiment, the number of times per one dot that the drive voltage applied to the actuators 98 is changed to the jetting voltage value—that is, the number of times of continuous firing that causes the ink liquid to be jetted from the nozzles 82—is varied depending on the size of the dots that are to be formed on the paper. In the image forming apparatus 10 pertaining to the present embodiment, when processing to form dots whose size is small (small-droplet dots) on the paper (hereinafter called “small droplet formation processing”) is executed, as shown in FIG. 6A as one example, the number of times that the drive voltage is changed from the reference voltage value to the jetting voltage value in a predetermined cycle is two times, and the ink liquid is jetted two times from the nozzle 82. On the other hand, when processing to form dots whose size is large (large-droplet dots) on the paper (hereinafter called “large droplet formation processing”) is executed, as shown in FIG. 6B as one example, the drive voltage is changed from the reference voltage value to the jetting voltage value six times in a cycle that is faster than the cycle when forming small-droplet dots, and the ink liquid is jetted six times from the nozzle 82 within the same amount of time as when jetting the ink liquid two times in the small droplet formation processing.

However, sometimes a frequency of pressure waves propagating in the ink liquid inside the common supply channel 90 when pressure has been applied to the ink liquid filling the pressure chamber 84—that is, the drive frequency of the actuators 98—and a resonance frequency of the common supply channel 90 become equal such that resonance occurs in the common supply channel 90. In this case, the pressure propagates unevenly to each of the pressure chambers 84, the speed of the ink liquid supplied to each of the pressure chambers 84 becomes uneven per pressure chamber 84, variations occur in the speed of the ink liquid that is jetted, and there is the potential for the intervals between the dots to change and for the ink liquid to not be jetted from the nozzles 82.

Thus, in the image forming apparatus 10 pertaining to the present embodiment, the actuators 98 apply pressure to the ink liquid filling the pressure chambers 84 to cause the ink liquid to be jetted from the nozzles 82 such that the frequency of the pressure waves propagating in the ink liquid inside the common supply channel 90 when pressure has been applied to the ink liquid filling the pressure chambers 84 does not become equal to the resonance frequency of the common supply channel 90.

Next, the action of the image forming apparatus 10 pertaining to the present embodiment will be described.

In the image forming apparatus 10 pertaining to the present embodiment, when a frequency corresponding to a cycle of pressure application when applying the jetting pressure to the ink liquid filling the pressure chambers 84 becomes equal to the resonance frequency of the common supply channel 90, the actuators 98 apply the non jetting pressure to the ink liquid filling the pressure chambers 84 before and after applying the jetting pressure.

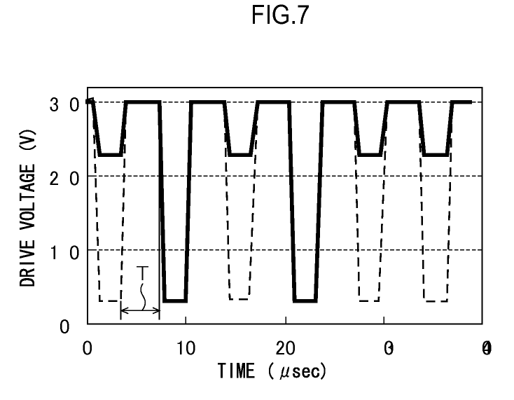

FIG. 7 is a graph showing one example of a temporal change in the drive voltage applied to the actuators 98 in the image forming apparatus 10 pertaining to the present embodiment when the frequency (drive frequency of the actuators 98) corresponding to the drive cycle of the actuators 98 that jet the ink liquid from the nozzles 82 in the small droplet formation processing becomes equal to the resonance frequency of the common supply channel 90.

As shown in FIG. 7, in the image forming apparatus 10 pertaining to the present embodiment, by changing the drive voltage to the non jetting voltage value before and after changing the drive voltage applied to the actuators 98 to the jetting voltage value, it is ensured that the frequency of the pressure waves propagating in the ink liquid inside the common supply channel 90 when pressure has been applied to the ink liquid filling the pressure chambers 84 does not become equal to the resonance frequency of the common supply channel 90.

Further, the drive cycle of the actuators 98 at the jetting voltage value represented by the dotted line in FIG. 7 is the drive cycle of the actuators 98 when jetting the ink liquid from the nozzles 82 in the large droplet formation processing. In this manner, in the small droplet formation processing pertaining to the present embodiment, by making the cycle in which the drive voltage is changed from the reference voltage value to the jetting voltage value and from the reference voltage value to the non jetting voltage value the same as the cycle in which the drive voltage is changed from the reference voltage value to the jetting voltage value in the large droplet formation processing, the jetting pressure and the non jetting pressure are applied to the ink liquid filling the pressure chambers 84 in the same cycle as the drive cycle of the actuators 98 in the large droplet formation processing.

Further, in the image forming apparatus 10 pertaining to the present embodiment, the waveform shape of the pulse (the size of the non jetting voltage value) when applying the non jetting pressure to the ink liquid filling the pressure chambers 84 is made the same as the waveform shape of the pulse that controls the state of the meniscuses, but the invention is not limited to this; it suffices as long as the non jetting pressure can be applied to the ink liquid filling the pressure chambers 84, and the waveform shape of the pulse when applying the non jetting pressure to the ink liquid filling the pressure chambers 84 may also be given a shape that differs from the waveform shape of the pulse that controls the state of the meniscuses.

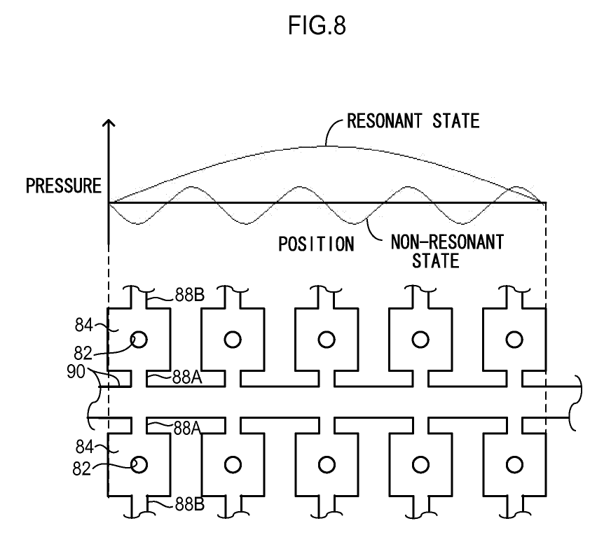

In FIG. 8, there are shown pressure distributions of the ink liquid inside the common supply channel 90 when the common supply channel 90 is in a resonant state and when the common supply channel 90 is not in a resonant state (non-resonant state).

As shown in FIG. 8, when the common supply channel 90 is in a resonant state, the pressure of the ink liquid becomes higher toward the center portion of the common supply channel 90, so high pressure becomes applied from the common supply channel 90 with respect to the ink liquid filling the pressure chambers 84 that are close to the center portion, and propagation of pressure into each of the pressure chambers 84 becomes uneven. On the other hand, by placing the common supply channel 90 in a non-resonant state, the cycle of pressure distribution becomes shorter and the magnitude of the pressure also becomes smaller in comparison to when the common supply channel 90 is in the resonant state, so propagation of uneven pressure from the common supply channel 90 into each of the pressure chambers 84 is controlled.

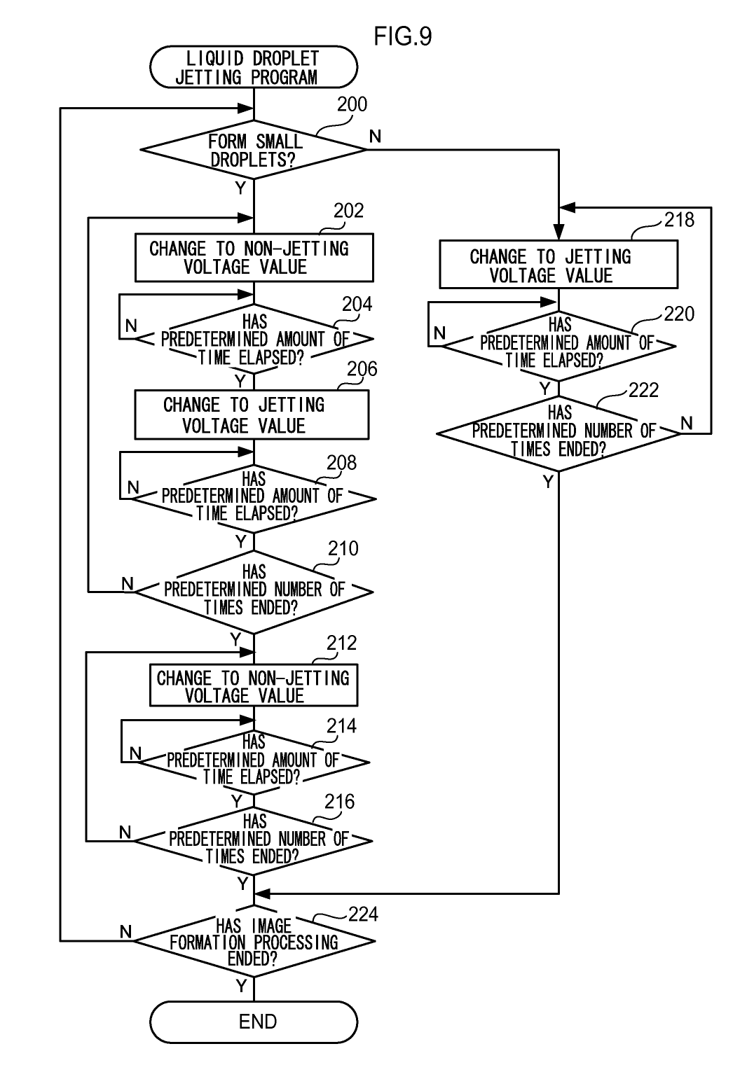

FIG. 9 is a flowchart showing a flow of processing by a liquid droplet jetting program that is executed by the CPU 100 when an instruction to execute image formation processing is inputted via the operation component 110 and the paper has reached the image forming section 16. The liquid droplet jetting program is stored beforehand in a region determined beforehand in the ROM 82 that serves as a storage medium. It will be noted that, while the liquid droplet jetting program is being executed, the paper continues to be conveyed at a speed determined beforehand such that an image represented by image information is formed on the paper.

First, in step 200, the CPU 100 determines whether or not to form small-droplet dots on the paper on the basis of the image information. When the determination is YES, the CPU 100 moves to step 202. When the determination is NO, the CPU 100 moves to step 218.

In step 202, the CPU 100 changes the drive voltage applied to the actuators 98 from the reference voltage value to the non jetting voltage value and returns the drive voltage to the reference voltage value after a certain amount of time elapses.

In the next step 204, the CPU 100 waits until a predetermined amount of time elapses, with the drive voltage applied to the actuators 98 remaining changed to the reference voltage value. It will be noted that the predetermined amount of time is, as shown in FIG. 7, made equal to a time interval T when the CPU 100 initiates change from the jetting voltage value to the reference voltage value to until the CPU 100 thereafter initiates change from the reference voltage value to the jetting voltage value in the large droplet formation processing.

In the next step 206, the CPU 100 changes the drive voltage applied to the actuators 98 from the reference voltage value to the jetting voltage value and returns the drive voltage to the reference voltage value after a certain amount of time elapses.

In the next step 208, the CPU 100 waits until the predetermined amount of time elapses, with the drive voltage applied to the actuators 98 remaining changed to the reference voltage value.

In the next step 210, the CPU 100 determines whether or not change from the reference voltage value to the non jetting voltage value and from the reference voltage value to the jetting voltage value has ended a predetermined number of times. When the determination is YES, the CPU 100 moves to step 212. When the determination is NO, the CPU 100 returns to step 202. It will be noted that, in the image forming apparatus 10 pertaining to the present embodiment, as one example of the small droplet formation processing, the CPU 100 applies a case where the ink liquid is jetted two times from the nozzles 82, so the predetermined number of times this time is two times.

In step 212, the CPU 100 changes the drive voltage applied to the actuators 98 from the reference voltage value to the non jetting voltage value and returns the drive voltage to the reference voltage value after a certain amount of time elapses.

In the next step 214, the CPU 100 waits until the predetermined amount of time elapses, with the drive voltage applied to the actuators 98 remaining changed to the reference voltage value.

In the next step 216, the CPU 100 determines whether or not change to the non-jetting voltage value has ended a predetermined number of times. When the determination is YES, the CPU 100 moves to step 224. When the determination is NO, the CPU 100 returns to step 212. It will be noted that, in the image forming apparatus 10 pertaining to the present embodiment, the drive cycle of the actuators 98 is made the same as the drive cycle of the actuators 98 in the large droplet formation processing, so the predetermined number of times this time is two times as one example.

Step 218 is a case where the determination was NO in the processing resulting from step 200, that is, a case where large-droplet dots are to be formed on the basis of the image information, and the CPU 100 changes the drive voltage applied to the actuators 98 from the reference voltage value to the jetting voltage value and returns the drive voltage to the reference voltage value after a certain amount of time elapses.

In the next step 220, the CPU 100 waits until the predetermined amount of time elapses, with the drive voltage applied to the actuators 98 remaining changed to the reference voltage value.

In the next step 222, the CPU 100 determines whether or not change to the non-jetting voltage value and the jetting voltage value has ended a predetermined number of times. When the determination is YES, the CPU 100 moves to step 224. When the determination is NO, the CPU 100 returns to step 218. It will be noted that, in the image forming apparatus 10 pertaining to the present embodiment, as one example of the large droplet formation processing, the CPU 100 applies a case where the ink liquid is jetted six times from the nozzles 82, so the predetermined number of times this time is six times.

In step 224, the CPU 100 determines whether or not formation of an image represented by the image information on the paper has ended. When the determination is NO, the CPU 100 returns to step 200. When the determination is YES, the CPU 100 ends the present program.

As described in detail above, in the image forming apparatus 10 pertaining to the present embodiment, the image forming apparatus 10 is equipped with the plural pressure chambers 84, in each of which is disposed the nozzle 82 for jetting the ink liquid filling the pressure chambers 84, and the common supply channel 90 that is equipped with the branching channels 88A connected to each of the pressure chambers 84 and which supplies the ink liquid to each of the pressure chambers 84 from the branching channels 88A such that the ink liquid fills each of the pressure chambers 84, and pressure is applied to the ink liquid filling the pressure chambers 84 and the ink liquid is jetted from the nozzles by the actuators 98 such that the frequency of the pressure waves propagating in the ink liquid inside the common supply channel 90 when pressure has been applied to the ink liquid filling the pressure chambers 84 does not become equal to the resonance frequency of the common supply channel 90; thus, when jetting the ink liquid from the nozzles 82 by applying pressure to the ink liquid filling the pressure chambers 84, the common supply channel 90 that supplies the ink liquid to the pressure chambers 84 can be controlled from resonating.

Further, when the frequency corresponding to the cycle of pressure application when applying, to the ink liquid filling the pressure chambers 84, the jetting pressure for causing the ink liquid to be jetted from the nozzles 82 becomes equal to the resonance frequency, the actuators 98 apply, to the ink liquid filling the pressure chambers 84, the non jetting pressure that does not cause the ink liquid to be jetted from the nozzles 82 at least one of before and after applying the jetting pressure; thus, the frequency of the pressure waves propagating in the ink liquid inside the common supply channel 90 can be easily shifted from the resonance frequency of the common supply channel 90.

Further, the actuators 98 apply the jetting pressure to the liquid filling the pressure chambers in each cycle of a first cycle (here, the drive cycle of the actuators 98 that jet the ink liquid from the nozzles 82 in the small droplet formation processing) and a second cycle (here, the drive cycle of the actuators 98 that jet the ink liquid from the nozzles 82 in the large droplet formation processing) where the cycle of pressure application is faster than the first cycle, and when the frequency corresponding to the first cycle becomes equal to the resonance frequency, the actuators 98 apply the jetting pressure and the non jetting pressure to the ink liquid filling the pressure chambers 84 in the same cycle as the second cycle; thus, the frequency of the pressure waves propagating in the ink liquid inside the common supply channel 90 can be more reliably shifted from the resonance frequency of the common supply channel 90, and the affect of the pressure waves propagating in the ink liquid inside the common supply channel 90 can, because of the jetting pressure and the non jetting pressure, be made the same as when the actuators 98 are driven in the second cycle.

Further, the magnitude of the non-jetting pressure is made equal to the magnitude of pressure that is applied to the ink liquid filling the pressure chambers 84 in order to control the state of the meniscuses formed in the nozzles 82; thus, the non jetting pressure can be easily applied to the ink liquid filling the pressure chambers 84.

Moreover, the plural nozzles 82 are two-dimensionally arrayed; thus, the speed at which an image is formed by jetting the ink liquid from the nozzles 82 can be made faster.

### Second Embodiment

In the present second embodiment, an example will be described where, when the drive frequency of the actuators 98 becomes equal to the resonance frequency of the common supply channel 90, the actuators 98 apply the jetting pressure to the ink liquid filling the pressure chambers 84 in a drive frequency that is small in comparison to the drive frequency. It will be noted that the configuration of the image forming apparatus 10 pertaining to the present second embodiment is the same as the configuration of the image forming apparatus 10 pertaining to the first embodiment (see FIG. 1 to FIG. 4), so description thereof will be omitted.

Next, the action of the image forming apparatus 10 pertaining to the present second embodiment will be described.

In the image forming apparatus 10 pertaining to the present second embodiment, when the drive frequency of the actuators 98 becomes equal to the resonance frequency of the common supply channel 90, the actuators 98 apply the jetting pressure to the ink liquid filling the pressure chambers 84 in a drive frequency that is small in comparison to the drive frequency and without changing the amount of the ink liquid that is jetted from the nozzles 82 per unit dot.

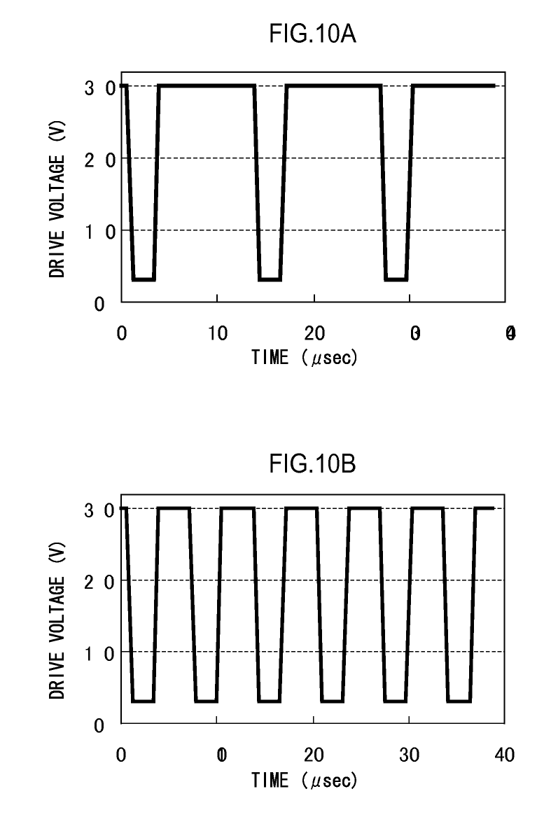

FIG. 10A is a graph showing one example of a temporal change in the drive voltage applied to the actuators 98 in the image forming apparatus 10 pertaining to the present second embodiment when the drive frequency corresponding to the drive cycle of the actuators 98 that jet the ink liquid from the nozzles 82 in conventional large droplet formation processing has become equal to the resonance frequency of the common supply channel 90. It will be noted that FIG. 10B is the same as FIG. 6B and is a graph showing one example of a temporal change in the drive voltage that is applied to the actuators 98 in conventional large droplet formation processing and which is the same as the resonance frequency of the common supply channel 90.

In the image forming apparatus 10 pertaining to the present second embodiment, as shown in FIG. 10A, in comparison to conventional large droplet formation processing, the drive frequency of the actuators 98 is made smaller than the resonance frequency of the common supply channel 90 by making fewer the number of times that the drive voltage is changed from the reference voltage value to the jetting voltage value. It will be noted that, in the image forming apparatus 10 pertaining to the present second embodiment, the number of times that the drive voltage is changed from the reference voltage value to the jetting voltage value is three times as one example, that is, one half of conventionally, but it goes without saying that the number of times that the drive voltage is changed from the reference voltage value to the jetting voltage value is not limited to three times.

Additionally, the sizes of the reference voltage value and the jetting voltage value are doubled in comparison to conventionally so that the jetting pressure becomes larger in comparison to conventionally in order to not change the amount of the ink liquid that is jetted from the nozzles 82 per unit dot, that is, in order to not change the size of the large droplets.

As described in detail above, in the image forming apparatus 10 pertaining to the present second embodiment, when the frequency corresponding to the cycle of pressure application when applying, to the ink liquid filling the pressure chambers 84, the jetting pressure for causing the ink liquid to be jetted from the nozzles 92 becomes equal to the resonance frequency, the actuators 98 apply the jetting pressure to the ink liquid filling the pressure chambers 84 in a frequency that is small in comparison to the frequency and without changing the amount of the ink liquid that is jetted from the nozzles 82 per unit dot; thus, the frequency of the pressure waves propagating inside the common supply channel 90 and the resonance frequency of the common supply channel 90 can be easily shifted.

The present invention has been described using the preceding embodiments, but the technical scope of the present invention is not limited to the scope described in the preceding embodiments. Various changes or improvements can be made to the preceding embodiments in a scope that does not depart from the gist of the invention, and embodiments to which such changes or improvements have been made are also included in the technical scope of the present invention.

Further, the preceding embodiments are not intended to limit the inventions pertaining to the claims, and it is not the case that all combinations of features described in the embodiments are essential to the solving component of the present invention. Inventions of various stages are included in the preceding embodiments, and various inventions can be extracted by combining the plural configural requirements that are disclosed. Even when several configural requirements are omitted from all of the configural requirements described in the preceding embodiments, inventions from which those several configural requirements have been omitted may be extracted as inventions as long as effects are obtained.

Further, in the preceding embodiments, a case has been described where the size of the dots formed on the paper are either large droplets or small droplets, but the present invention is not limited to this and may also be configured to form dots of a size between large droplets and small droplets (middle-size droplets) or droplets of other sizes in addition to large droplets and small droplets.

In addition, the configuration of the image forming apparatus 10 described in the preceding embodiments (see FIG. 1 to FIG. 4) is only one example, and unnecessary portions can be omitted and new portions can be added in a scope that does not depart from the gist of the present invention.

Further, the flow of processing by the liquid droplet jetting program described in the preceding embodiments (see FIG. 9) is also only one example, and unnecessary steps can be omitted and new steps can be added in a scope that does not depart from the gist of the present invention.

A first aspect of the present invention is a liquid droplet jetting apparatus including: plural pressure chambers, in each of which is disposed a nozzle for jetting a liquid filling the pressure chambers; a common supply channel that is equipped with branching channels connected to each of the pressure chambers and which supplies the liquid to each of the pressure chambers from the branching channels such that the liquid fills each of the pressure chambers; and a pressure applying component applies pressure to the liquid filling the pressure chambers to cause the liquid to be jetted from the nozzles such that a frequency of pressure waves propagating in the liquid inside the common supply channel when pressure has been applied to the liquid filling the pressure chambers does not become equal to a resonance frequency of the common supply channel.

According to the liquid droplet jetting apparatus of the first aspect, the liquid droplet jetting apparatus is equipped with the plural pressure chambers, in each of which is disposed the nozzle for jetting the liquid filling the pressure chambers, and the common supply channel that is equipped with the branching channels connected to each of the pressure chambers and which supplies the liquid to each of the pressure chambers from the branching channels such that the liquid fills each of the pressure chambers, and pressure is applied to the liquid filling the pressure chambers and the liquid is jetted from the nozzles by the pressure applying component such that the frequency of the pressure waves propagating in the liquid inside the common supply channel when pressure has been applied to the liquid filling the pressure chambers does not become equal to the resonance frequency of the common supply channel.

In this manner, according to the liquid droplet jetting apparatus of the first aspect, pressure is applied to the liquid filling the pressure chambers such that the frequency of the pressure waves propagating in the liquid inside the common supply channel when pressure has been applied to the liquid filling the pressure chambers does not become equal to the resonance frequency of the common supply channel; thus, the common supply channel can be controlled from resonating when jetting the liquid from the nozzles by applying pressure to the liquid filling the pressure chambers.

In the liquid droplet jetting apparatus of the first aspect, when a frequency corresponding to a cycle of pressure application when applying, to the liquid filling the pressure chambers, jetting pressure for causing the liquid to be jetted from the nozzles becomes equal to the resonance frequency, the pressure applying component may apply, to the liquid filling the pressure chambers, non jetting pressure that does not cause the liquid to be jetted from the nozzles at least one of before and after applying the jetting pressure. Thus, the frequency of the pressure waves propagating in the liquid inside the common supply channel can be easily shifted from the resonance frequency of the common supply channel.

In the above-described aspect, the pressure applying component may apply the jetting pressure to the liquid filling the pressure chambers in each cycle of a first cycle and a second cycle where the cycle of pressure application is faster than the first cycle, and when the frequency corresponding to the first cycle becomes equal to the resonance frequency, the pressure applying component may apply the jetting pressure and the non-jetting pressure to the liquid filling the pressure chambers in the same cycle as the second cycle. Thus, the frequency of the pressure waves propagating in the liquid inside the common supply channel can be more reliably shifted from the resonance frequency of the common supply channel, and the affect of the pressure waves propagating in the liquid inside the common supply channel can, because of the jetting pressure and the non jetting pressure, be made the same as when the pressure applying component is driven in the second cycle.

In the liquid droplet jetting apparatus of the above-described aspect, a magnitude of the non-jetting pressure may be made equal to a magnitude of pressure that is applied to the liquid filling the pressure chambers in order to control the state of meniscuses formed in the nozzles. Thus, the non jetting pressure can easily be applied to the liquid filling the pressure chambers.

In the liquid droplet jetting apparatus of the first aspect, when a frequency corresponding to a cycle of pressure application when applying, to the liquid filling the pressure chambers, jetting pressure for causing the liquid to be jetted from the nozzles becomes equal to the resonance frequency, the pressure applying component may apply the jetting pressure to the liquid filling the pressure chambers in a frequency that is small in comparison to the frequency and without changing the amount of the liquid that is jetted from the nozzles per unit dot. Thus, the frequency of the pressure waves propagating in the liquid inside the common supply channel and the resonance frequency of the common supply channel can be easily shifted.

The liquid droplet jetting apparatus of the above-described aspect may be one where a plurality of the nozzles are two-dimensionally arrayed. Thus, the speed at which an image is formed by jetting the liquid from the nozzles can be made faster.

A second aspect of the present invention is a liquid droplet jetting method of a liquid droplet jetting apparatus, wherein the liquid droplet jetting apparatus includes a plurality of pressure chambers, in each of which is disposed a nozzle for jetting a liquid filling the pressure chambers, and a common supply channel that is equipped with branching channels connected to each of the pressure chambers and which supplies the liquid to each of the pressure chambers from the branching channels such that the liquid fills each of the pressure chambers, and the liquid droplet jetting method includes applying pressure to the liquid filling the pressure chambers to cause the liquid to be jetted from the nozzles such that a frequency of pressure waves propagating in the liquid inside the common supply channel when pressure has been applied to the liquid filling the pressure chambers does not become equal to a resonance frequency of the common supply channel.

As described above, according to the present invention, there is obtained the excellent effect that, when jetting a liquid from nozzles by applying pressure to a liquid filling pressure chambers, a common supply channel that supplies the liquid to the pressure chambers can be controlled from resonating.

What is claimed is:

1. A liquid droplet jetting apparatus comprising:
a plurality of pressure chambers, in each of which is disposed a nozzle for jetting a liquid filling the pressure chambers;
a common supply channel that is equipped with branching channels connected to each of the pressure chambers and which supplies the liquid to each of the pressure chambers from the branching channels such that the liquid fills each of the pressure chambers; and
a pressure applying component that applies pressure to the liquid filling the pressure chambers to cause the liquid to be jetted from the nozzles such that a frequency of pressure waves propagating in the liquid inside the common supply channel when pressure has been applied to the liquid filling the pressure chambers does not become equal to a resonance frequency of the common supply channel.

2. The liquid droplet jetting apparatus of claim 1, wherein when a frequency corresponding to a cycle of pressure application when applying, to the liquid filling the pressure chambers, jetting pressure for causing the liquid to be jetted from the nozzles becomes equal to the resonance frequency, the pressure applying component applies, to the liquid filling the pressure chambers, non jetting pressure that does not cause the liquid to be jetted from the nozzles at least one of before and after applying the jetting pressure.

3. The liquid droplet jetting apparatus of claim 2, wherein the pressure applying component applies the jetting pressure to the liquid filling the pressure chambers in each cycle of a first cycle and a second cycle where the cycle of pressure application is faster than the first cycle, and when the frequency corresponding to the first cycle becomes equal to the resonance frequency, the pressure applying component applies the jetting pressure and the non jetting pressure to the liquid filling the pressure chambers in the same cycle as the second cycle.

4. The liquid droplet jetting apparatus of claim 2, wherein a magnitude of the non-jetting pressure is made equal to a magnitude of pressure that is applied to the liquid filling the pressure chambers in order to control the state of meniscuses formed in the nozzles.

5. The liquid droplet jetting apparatus of claim 1, wherein when a frequency corresponding to a cycle of pressure application when applying, to the liquid filling the pressure chambers, jetting pressure for causing the liquid to be jetted from the nozzles becomes equal to the resonance frequency, the pressure applying component applies the jetting pressure to the liquid filling the pressure chambers in a frequency that is small in comparison to the frequency and without changing the amount of the liquid that is jetted from the nozzles per unit dot.

6. The liquid droplet jetting apparatus of claim 1, wherein a plurality of the nozzles are two-dimensionally arrayed.

7. A liquid droplet jetting method of a liquid droplet jetting apparatus, wherein
the liquid droplet jetting apparatus comprises
a plurality of pressure chambers, in each of which is disposed a nozzle for jetting a liquid filling the pressure chambers, and
a common supply channel that is equipped with branching channels connected to each of the pressure chambers and which supplies the liquid to each of the pressure chambers from the branching channels such that the liquid fills each of the pressure chambers, and
the liquid droplet jetting method comprises
applying pressure to the liquid filling the pressure chambers to cause the liquid to be jetted from the nozzles such that a frequency of pressure waves propagating in the liquid inside the common supply channel when pressure has been applied to the liquid filling the pressure chambers does not become equal to as a resonance frequency of the common supply channel.

8. The liquid droplet jetting method of claim 7, wherein when a frequency corresponding to a cycle of pressure application when applying, to the liquid filling the pressure chambers, jetting pressure for causing the liquid to be jetted from the nozzles becomes equal to the resonance frequency, the method applies, to the liquid filling the pressure chambers, non jetting pressure that does not cause the liquid to be jetted from the nozzles at least one of before and after applying the jetting pressure.

9. The liquid droplet jetting method of claim 8, wherein the method applies the jetting pressure to the liquid filling the pressure chambers in each cycle of a first cycle and a second cycle where the cycle of pressure application is faster than the first cycle, and when the frequency corresponding to the first cycle becomes equal to the resonance frequency, the method applies the jetting pressure and the non jetting pressure to the liquid filling the pressure chambers in the same cycle as the second cycle.

10. The liquid droplet jetting method of claim 8, wherein a magnitude of the non-jetting pressure is made equal to a magnitude of pressure that is applied to the liquid filling the pressure chambers in order to control the state of meniscuses formed in the nozzles.

11. The liquid droplet jetting method of claim 7, wherein when a frequency corresponding to a cycle of pressure application when applying, to the liquid filling the pressure chambers, jetting pressure for causing the liquid to be jetted from the nozzles becomes equal to the resonance frequency, the method applies the jetting pressure to the liquid filling the pressure chambers in a frequency that is small in comparison to the frequency and without changing the amount of the liquid that is jetted from the nozzles per unit dot.
